(19) United States
(12) Patent Application Publication
(10) Pub. No.: US 2012/0217930 A1
(43) Pub. Date: Aug. 30, 2012

(54) HOLDER FOR COMPACT ELECTRIC DEVICE

(75) Inventors: Fumio Taniguchi, Shiga-ken (JP); Daisuke Sone, Shiga-ken (JP); Harumi Fukuki, Fukuoka-ken (JP); Yasunori Ueda, Shiga-ken (JP)

(73) Assignee: Panasonic Corporation, Osaka (JP)

(21) Appl. No.: 13/358,445

(22) Filed: Jan. 25, 2012

(30) Foreign Application Priority Data
Feb. 28, 2011 (JP) 2011-043045

(51) Int. Cl. H02J 7/00

(52) U.S. Cl. 320/115

(57) ABSTRACT

A holder that holds a compact electric device includes a contact fitting that resiliently contacts a contact arranged in a surface of the electric device. A holding element is coupled to the contact fitting and supported by the holder. An urging portion urges the contact fitting from the holder to the contact of the electric device.

### CROSS-REFERENCE TO RELATED APPLICATIONS

This application is based upon and claims the benefit of priority from prior Japanese Patent Application No. 2011-043045, filed on Feb. 28, 2011, the entire contents of which are incorporated herein by reference.

### BACKGROUND

The present invention relates to a holder for a compact electric device such as an electric shaver.

One example of a holder that holds, for example, an electric shaver is a cleaning charger, which has a cleaning function and a charging function. When the electric shaver is held on the cleaning charger, the electric shaver and cleaning charger are electrically connected, and the cleaning charger controls the cleaning and charging of the electric shaver.

The cleaning charger includes a contact unit, which electrically connects the electric shaver to the cleaning charger. Japanese Laid-Open Patent Publication No. 2008-18128 describes one example of such a contact unit. The contact unit includes a contact formed from a resilient metal to stably decrease contact resistance at its contact portion. A precious metal is plated to the contact.

In the contact unit described in the above publication, the contact, which includes a resilient leg to ensure the resiliency of the contact, is entirely plated by a precious metal. This increases the cost of components.

Japanese Patent No. 4036102 describes another prior art example of a contact unit. In the contact unit described in this patent publication, a contact, which includes a ridge-shaped contact portion, is also entirely plated by a precious metal. This increases the cost of components.

Accordingly, precious metal may be plated to only the contact portion of the contact to reduce the plating area. However, such partial plating method requires accurate positioning for plating. This results in a complicated plating device. Thus, the cost of components may not be decreased when the components are manufactured in small lots.

### SUMMARY

One aspect of the present invention is a holder that holds a compact electric device. The holder includes a contact fitting that resiliently contacts a contact arranged in a surface of the electric device. A holding element is coupled to the contact fitting and supported by the holder. An urging portion urges the contact fitting from the holder toward the contact of the electric device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing a cleaning charger serving as a holder;

FIG. 2 is a rear view showing an electric shaver, which is one example of an electric device;

FIG. 3 is a front view showing the cleaning charger of FIG. 1;

FIG. 4 is an exploded perspective view showing a contact unit arranged in the cleaning charger of FIG. 1;

FIG. 5 is an exploded perspective view showing a main part of the contact unit of FIG. 4;

FIG. 6 is a cross-sectional view showing the contact unit of FIG. 5;

FIG. 7 is a cross-sectional view showing a contact fitting and a holding element of FIG. 5;

FIG. 8 is a side view showing the contact fitting and the holding element of FIG. 7;

FIG. 9 is a cross-sectional view taken along line A-A in FIG. 8;

FIG. 10 is a cross-sectional view showing the contact unit of FIG. 4; and

FIG. 11 is a side view showing the layout of connection cords in the contact unit of FIG. 4.

### DETAILED DESCRIPTION OF THE INVENTION

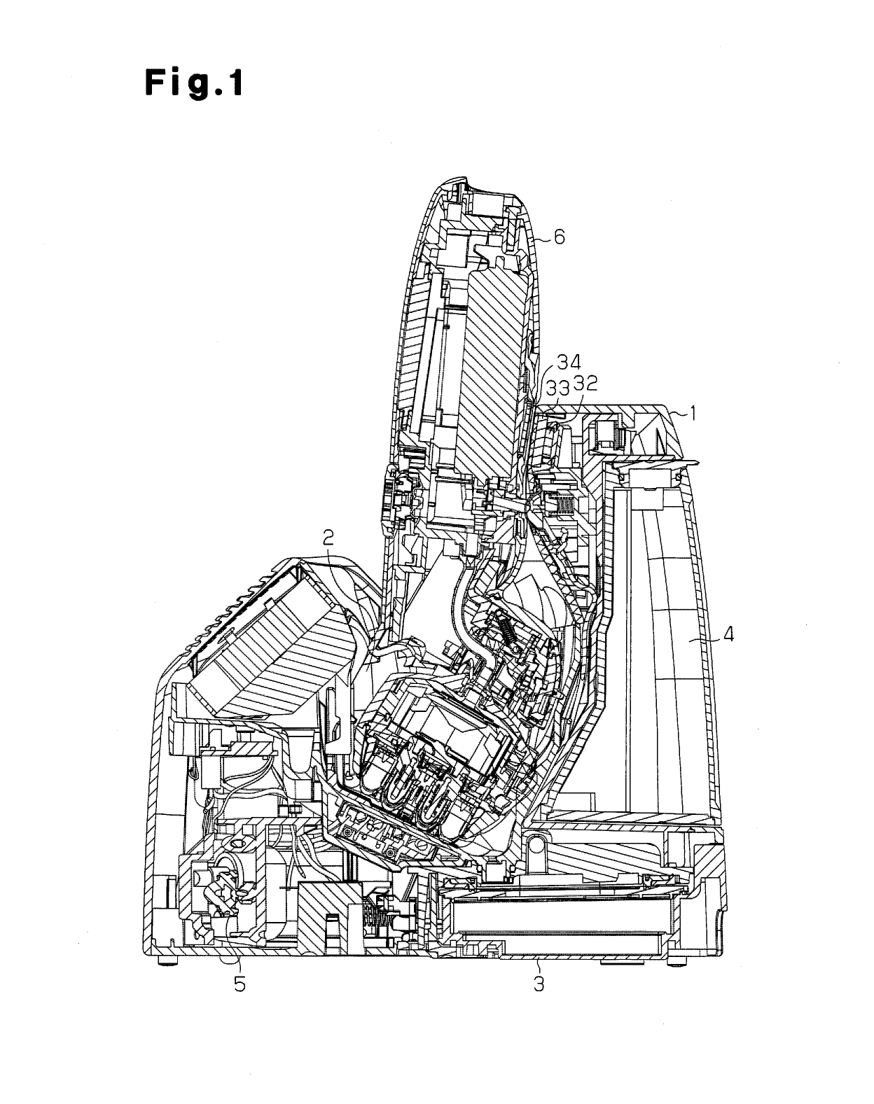

A holder according to one embodiment will now be described. Referring to FIG. 1, a cleaning charger, which is one example of a holder, includes a main body 1. A receptacle-like holding unit 2 is formed in the main body 1. The main body 1 of the cleaning charger includes a cleaning agent container 3, which is provided with a filter, a cleaning water container 4, and a pump 5. The cleaning charger holds an electric shaver 6, which is one example of an electric device, with the holding unit 2. The cleaning charger cleans the electric shaver 6 with cleaning water, which circulates through the holding unit 2, the cleaning agent container 3, and the cleaning water container 4. Further the cleaning charger is capable of charging the electric shaver 6.

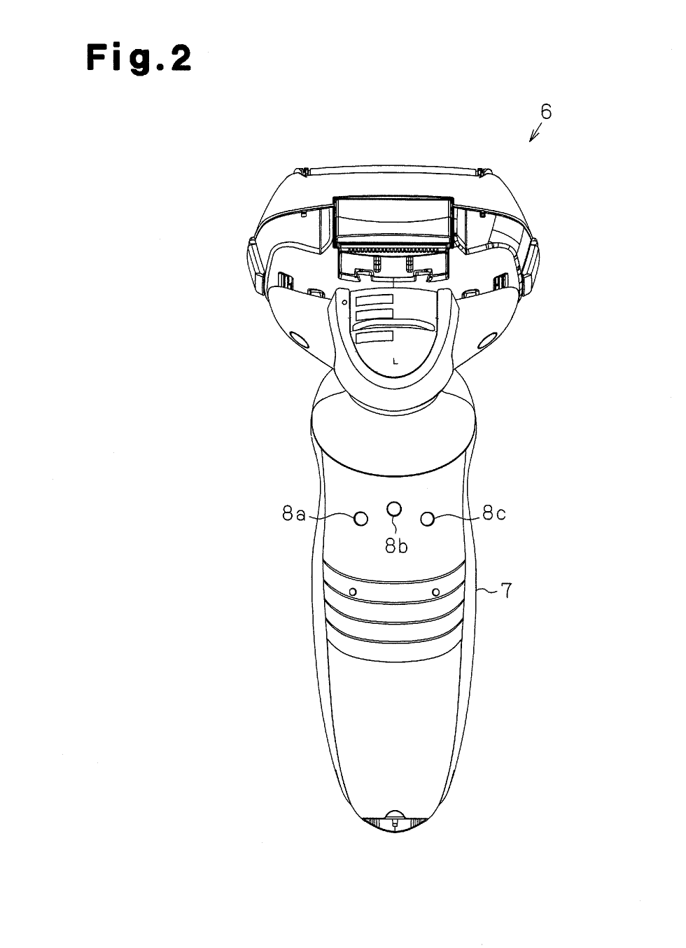

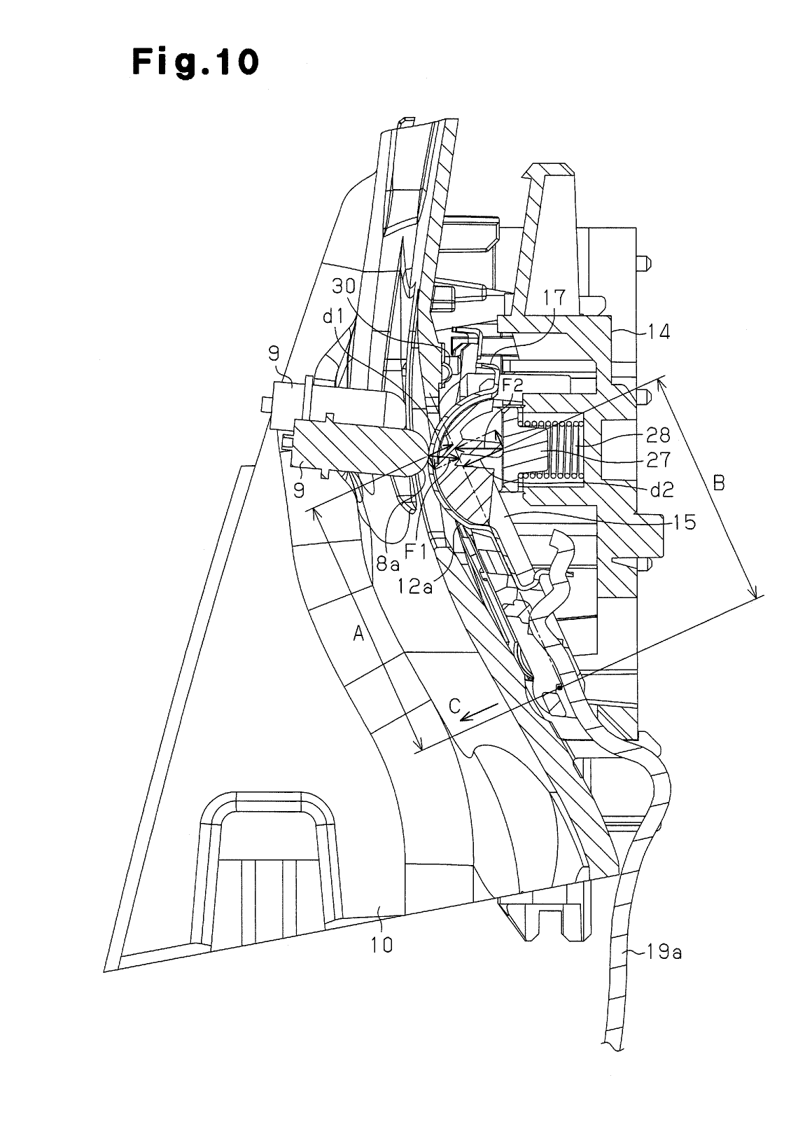

As shown in FIG. 2, the electric shaver 6 includes a grip 7. Three contacts 8a to 8c are formed on the rear surface of the grip 7. Referring to FIG. 10, each of the contacts 8a to 8c includes a cylindrical contact pin 9. The contact pin 9 includes a semispherical distal portion, which projects from the surface of the grip 7, and a basal portion, which is electrically connected to a control unit (not shown) incorporated in the electric shaver 6. FIG. 10 shows only the contact pins 9 and does not show the grip 7.

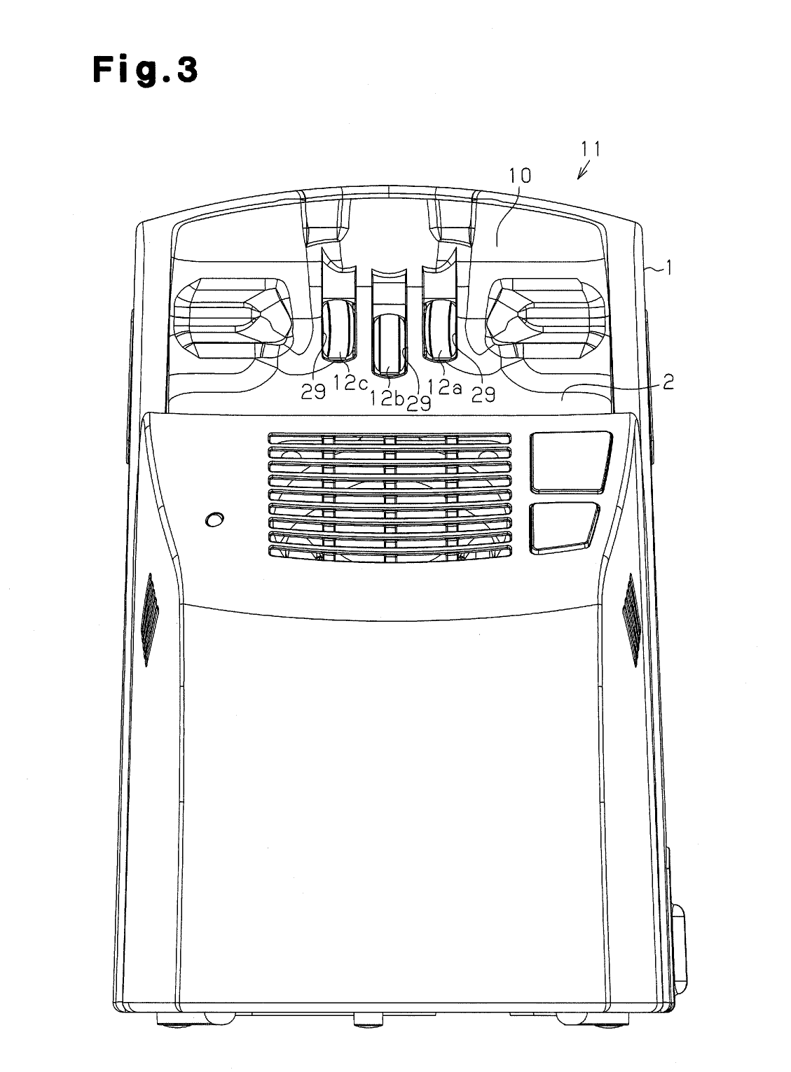

Referring to FIG. 3, the cleaning charger further includes a contact unit 11 arranged in the rear side of the holding unit 2 of the main body 1, that is, the surface facing toward the contacts 8a to 8c. The contact unit 11 includes a base 10. Three contact fittings 12a to 12c are exposed from the base 10.

When the contacts 8a to 8c of the electric shaver 6 are in contact with the contact fittings 12a to 12c, the contact unit 11 detects attachment of the electric shaver 6 to the holding unit 2. The control unit, which is incorporated in the cleaning charger, is capable of transmitting a signal for controlling cleaning and charging to the electric shaver 6 via the contact fittings 12a to 12c and the contacts 8a to 8c.

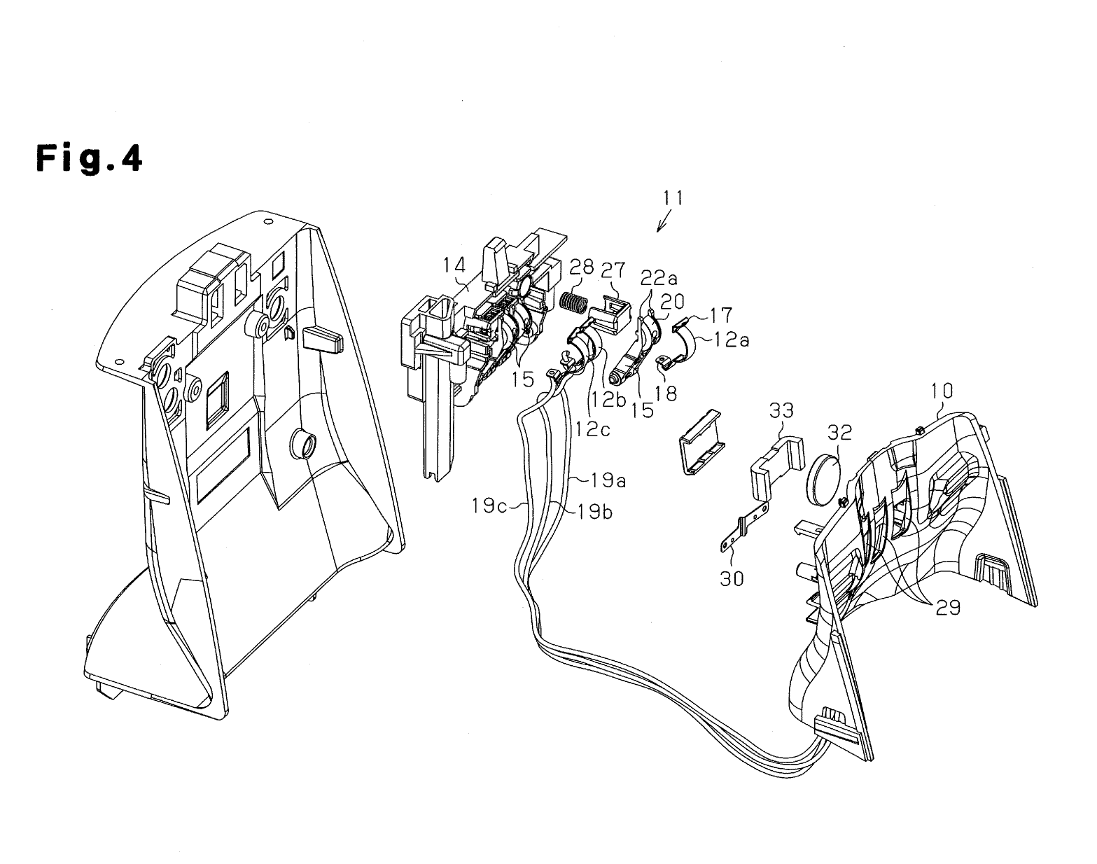

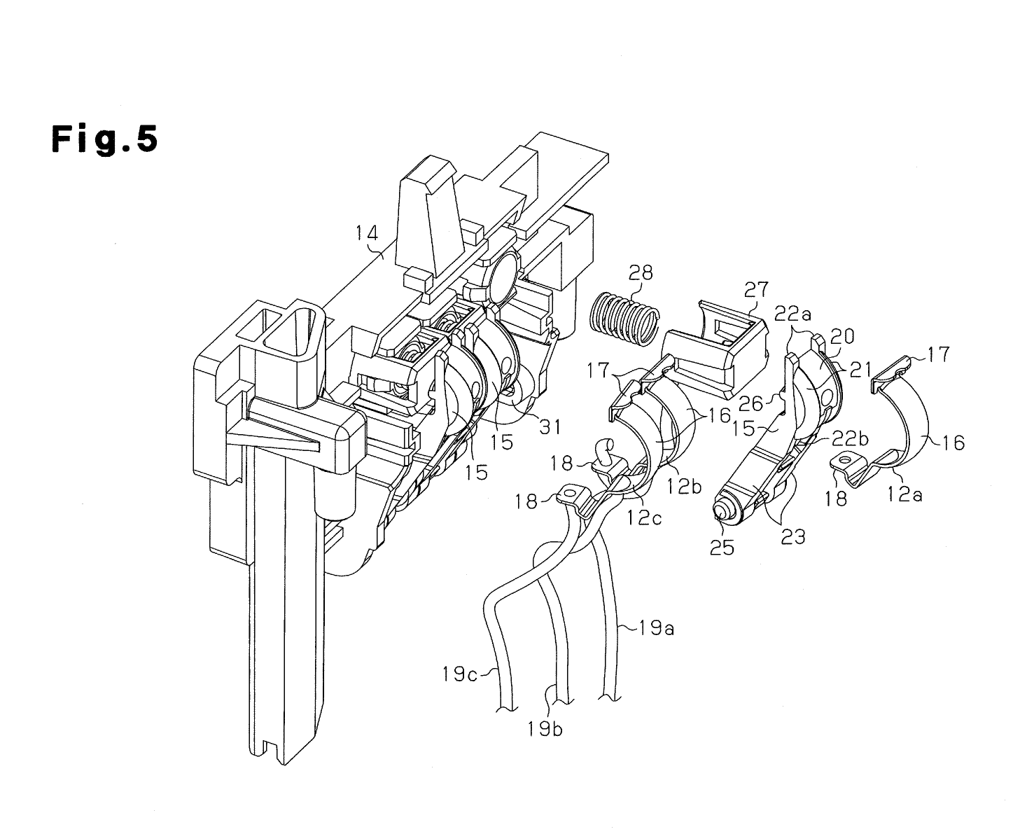

The specific structure of the contact unit 11 will now be described. Referring to FIGS. 4 and 5, a pushing base 14 is coupled to the base 10. The pushing base 14 includes three holding elements 15. The contact fittings 12a to 12c are respectively coupled to the three holding elements 15.

As shown in FIG. 5, each of the contact fittings 12a to 12c includes an arcuate contact portion 16, which is formed by bending a conductive metal plate. In other words, the contact portion 16 is formed by cutting out a strip of the surface of a spherical body from the front.

Each of the contact fittings 12a to 12c includes a top portion, which defines a flap 17. The flap 17 is formed by bending the top portion of the corresponding contact fitting outward relative to the curved surface of the contact portion 16. Further, each of the contact fittings 12a to 12c includes a bottom portion, which defines a terminal 18. The terminal 18 is formed by bending the bottom portion of the corresponding contact fitting inward relative to the curved surface of the contact portion 16. The terminals 18 are bent so that they are located above the bottom end of the corresponding contact fittings 12a to 12c.

The surface of each of the contact fittings 12a to 12c is plated with a precious metal such as gold. The terminals 18 of the contact fittings 12a to 12c are soldered to one ends of connection cords 19a to 19c, respectively. The other ends of the connection cords 19a to 19c are connected to the control unit in the main body 1.

The three holding elements 15 are formed from a synthetic resin. A seat 20 is formed in an upper portion of each holding element 15, as viewed in FIG. 5. The seat 20 includes an arcuate surface, which conforms to the contact portion 16 of each of the contact fittings 12a to 12c. A flange 21 is formed in each of two opposite sides of the arcuate surface of the seat 20.

Referring to the cross-sectional view of FIG. 9, the flanges 21 extend vertically to a height that is generally the same as the thickness of the corresponding contact fitting 12a from the arcuate surface of the seat 20. In other words, the flanges 21 are formed to be circular along the side surfaces of the seat 20. Thus, the flanges 21 cover the cut edges of the corresponding contact fitting 12a.

As shown in FIG. 5, the seat 20 includes a top end defining catches 22a. The catches 22a are engaged with the flap 17 of the corresponding contact fitting 12a. As shown in FIG. 9, the holding element 15 is formed below the seat 20 and is bifurcated in the widthwise direction of the seat 20 to form two arms 23. Catches 22b are formed in the top portion of the arms 23. The catches 22b of the arms 23 project toward each other.

The contact portion 16 of the contact fitting 12a is fitted to the corresponding holding element 15 along the seat 20. The flap 17 is engaged with the catches 22a, and the lower portion of the contact portion 16 is engaged with the catches 22b. In this manner, the contact fitting 12a is attached to the holding element 15 as shown in FIG. 7. In the same manner, the other contact fittings 12b and 12c are attached to the corresponding holding elements 15, respectively.

As shown in FIGS. 7 and 9, three guide pieces 24 are arranged between the two arms 23. Each guide piece 24 extends to an intermediate position between the two arms 23 from one of the two arms 23 toward the other one of the two arms 23. The upper and lower guide pieces 24 are located at a front part of the arms 23, and the middle guide piece 24 is located at a rear part of the arms 23.

The connection cords 19a to 19c, which are respectively soldered to the terminals 18 of the contact fittings 12a to 12c, are guided downward along the arms 23 by the three guide pieces 24.

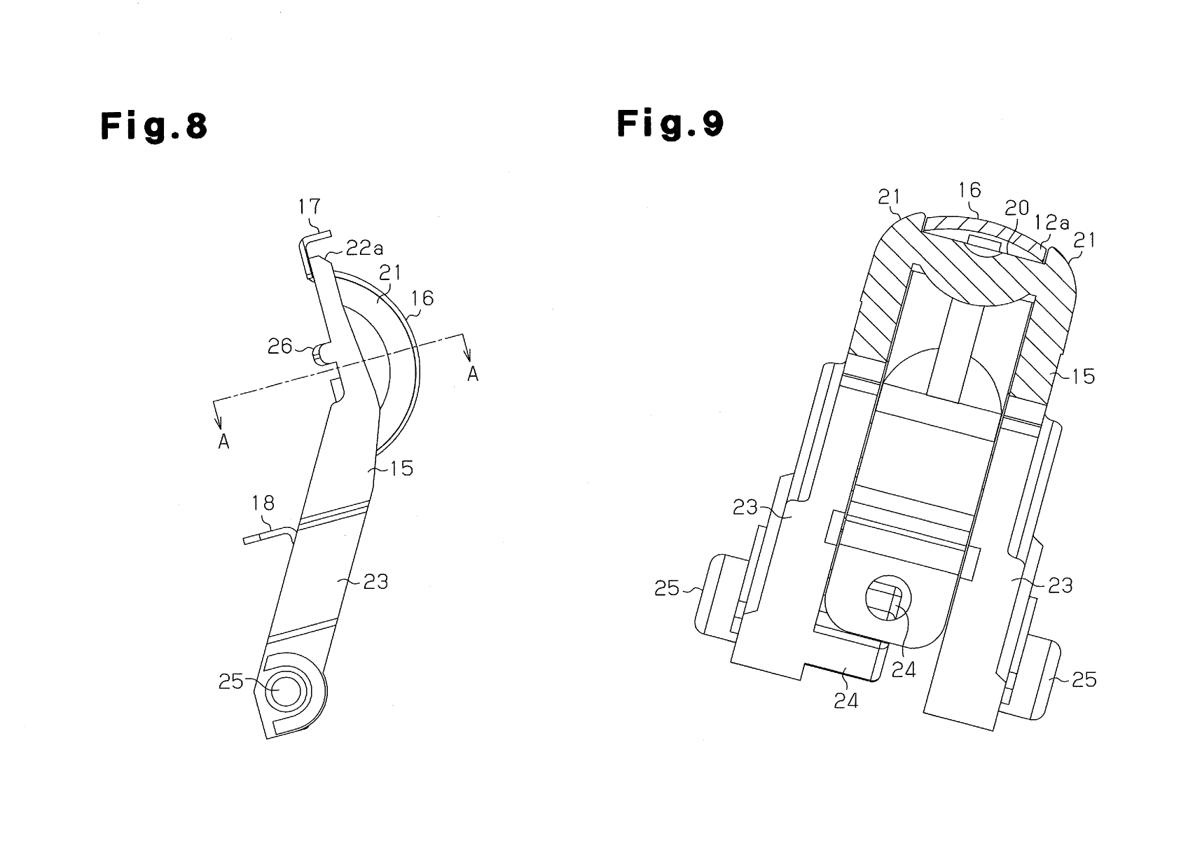

As shown in FIGS. 8 and 9, the holding element 15 includes a support shaft 25, which projects outward from the outer surface of the lower part of each arm 23. The support shafts 25 are supported by bearings 31 (see FIG. 5) formed in the pushing base 14. The bearings 31 pivotally hold the bottom portions of the arms 23 (i.e., basal portion of the holding element 15).

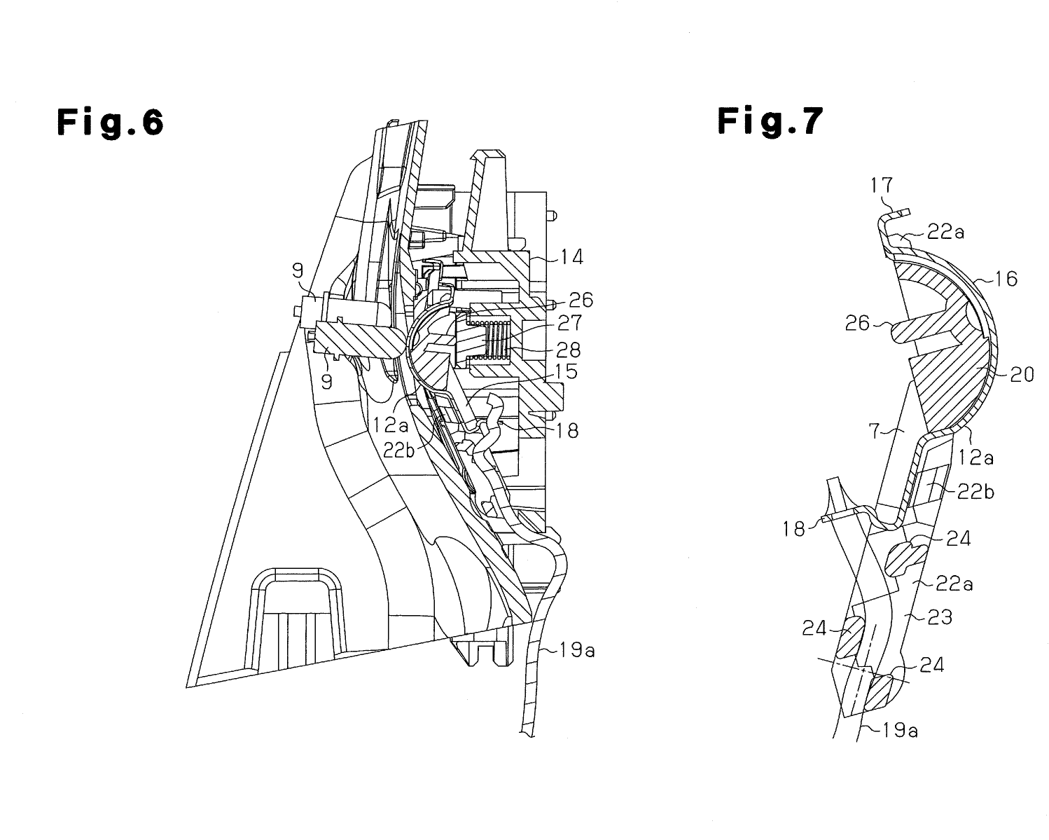

As shown in FIGS. 5 and 6, an abutment piece 26 projects rearward from a rear surface of the seat 20 in the holding element 15. An urging member 27, which abuts the abutment piece 26, is supported by the pushing base 14 to be movable in the frontward and rearward directions.

A coil spring 28 is arranged between the urging member 27 and the pushing base 14. The urging member 27 pushes the top portion of the holding element 15 from the pushing base 14 toward the base 10 with the urging force of the coil spring 28. The coil spring 28 is one example of an urging portion.

As shown in FIGS. 3 and 4, the base 10 includes three openings 29 from which the contact portions 16 of the contact fittings 12a to 12c are exposed toward the holding unit 2. Accordingly, the peaks of the contact portions 16 in the contact fittings 12a to 12c are exposed from the openings 29.

A main body detection plate 30 is arranged in the rear surface of the base 10. When the electric shaver 6 is detached from the holding unit 2, the contact portions 16 of the contact fittings 12a to 12c are exposed from the openings 29 toward the holding unit 2. In this state, the flaps 17 of the contact fittings 12a and 12b are in contact with the main body detection plate 30. The main body detection plate 30 is connected by a connection cord (not shown) to the control unit of the cleaning charger.

When the flaps 17 of the contact fittings 12a and 12b are in contact with the main body detection plate 30, the control unit detects detachment of the electric shaver 6.

When the electric shaver 6 is attached to the holding unit 2, the contacts 8a to 8c push the contact portions 16 of the contact fittings 12a to 12c. This pushes the top portions of the holding elements 15 and separates the flaps 17 of the contact fittings 12a and 12b from the main body detection plate 30. As a result, the control unit detects attachment of the electric shaver 6.

As shown in FIG. 10, when the contacts 8a to 8c push the contact fittings 12a to 12c, the contacts 8a to 8c apply force F1 to the contact fittings 12a to 12c, and the urging members 27 apply force F2 to the abutment pieces 26 of the holding elements 15. In this state, component forces d1 and d2 act as torque on the support shafts 25 of the holding elements 15.

When the length from the support shafts 25 to the application point of the component force d1 is defined as the lever length A and the length from the support shafts 25 to the application point of the component force d2 is defined as the lever length B, lever length A is greater than lever length B. As a result, when the contacts 8a to 8c push the contact fittings 12a to 12c, the components forces d1 and d2 produce a reactive force at the support shafts 25 acting toward the base 10, that is, in the direction of arrow C shown in FIG. 10.

The bearings 31, which are arranged on the pushing base 14 to support the support shafts 25, are formed to stop movement of the support shafts 25 in the direction of arrow C in FIG. 10. In other words, the bearings 31 are open in a direction opposite to the direction of arrow C.

A magnet 32 and a yoke 33 are arranged on the base 10 above the main detection plate 30, as viewed in FIG. 4. The magnet 32 attracts a metal plate 34 (refer to FIG. 1), which is arranged on the electric shaver 6, with magnetic force concentrated by the yoke 33 to stably hold the electric shaver 6 in the holding unit 2.

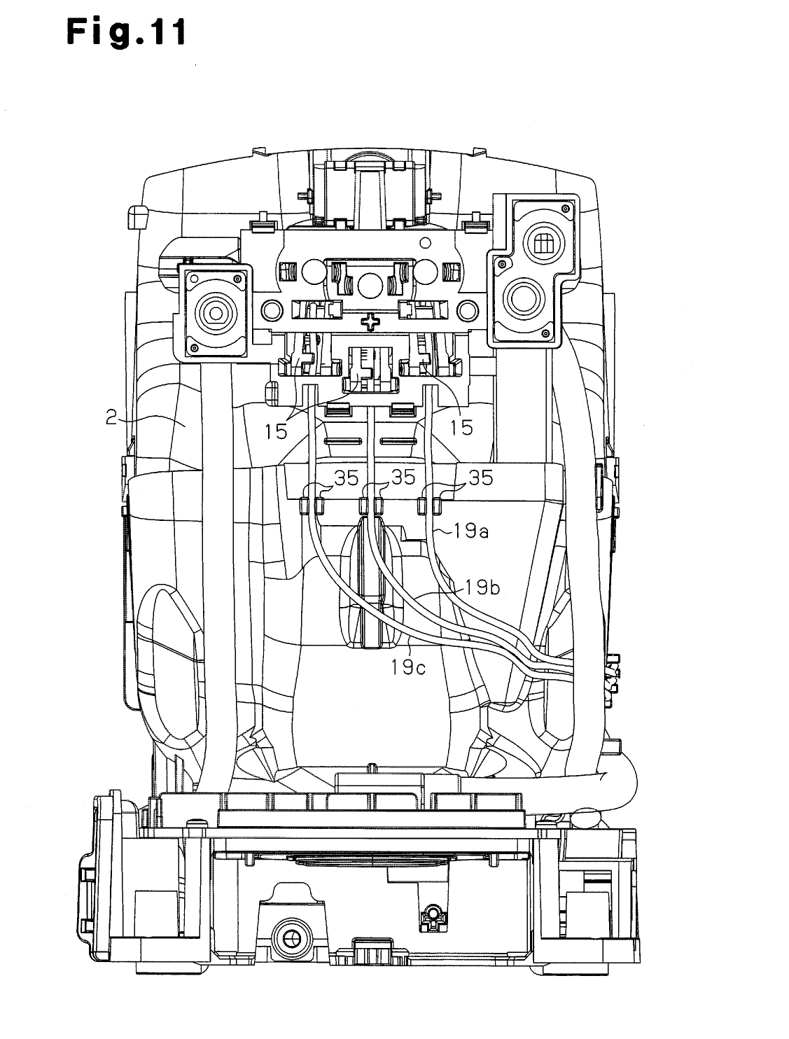

As shown in FIG. 11, the middle parts of the connection cords 19a to 19c are held by tabs 35 formed in the rear surface of the holding unit 2. The connection cords 19a to 19c are held in a loose state by the holding elements 15, the tabs 35, and further fasteners (not shown). The tabs 35 are examples of a cord holding portion.

The operation of the contact unit 11 will now be described.

In a state in which the electric shaver 6 is detached from the holding unit 2, the urging force of the coil springs 28 expose the peaks of the contact portions 16 on the contact fittings 12a to 12c from the openings 29 toward the holding unit 2. In this state, the flaps 17 of the contact fittings 12a and 12b are in contact with the main body detection plate 30. Thus, the control unit detects detachment of the electric shaver 6.

When the electric shaver 6 is attached to the holding unit 2, the contacts 8a to 8c of the electric shaver 6 push the peaks of the contact fittings 12a to 12c. This pivots each holding element 15 about its bottom portion (support shafts 25) and separates the flaps 17 of the contact fittings 12a and 12b from the main body detection plate 30.

Consequently, the control unit detects attachment of the electric shaver 6. In this state, contact of the contact fittings 12a to 12c with the contacts 8a to 8c of the electric shaver 6 electrically connects the control unit and the electric shaver 6. Thus, a cleaning operation or charging operation is performed on the electric shaver 6.

The contact unit 11 has the advantages described below.

(1) The contact fittings 12a to 12c are coupled to the holding elements 15 which are urged by the coil springs 28. Thus, the contact fittings 12a to 12c do not have to be resilient. This allows for a decrease in the surface area of the contact fittings 12a to 12c to which a precious metal is plated. Thus, component costs can be reduced.

(2) The holding elements 15 include the flanges 21, which sandwich the contact fittings 12a to 12c and cover the cut edges of the contact fittings 12a to 12c. Thus, the contact fittings 12a to 12c do not have to be formed to hide the cut edges. This simplifies the manufacturing process of the contact fittings 12a to 12c and reduces component costs.

(3) The flanges 21 of the holding elements 15 are formed to have a height that is greater than or equal to the thickness of the contact fittings 12a to 12c. Thus, the cut edges of the contact fittings 12a to 12c are not exposed from the openings 29 of the base 10. This prevents the cutting edges of the contact fittings 12a to 12c from becoming caught by the contacts 8a to 8c of the electric shaver 6 or the fingers of the user.

(4) As shown in FIG. 10, the lever length A is greater than the lever length B. Accordingly, when the contacts 8a to 8c push the contact fittings 12a to 12c, the components forces d1 and d2 produce a reactive force at the support shafts 25 acting toward the base 10. Thus, the bearings 31 may be formed to open in a direction opposite to the direction of arrow C of FIG. 10. This simplifies the structure of the bearings 31 and facilitates the coupling of the holding elements 15 to the pushing base 14.

(5) The guide pieces 24 guide the connection cords 19a to 19c, which are soldered to the contact fittings 12a to 12c, to near the support shafts 25 along the arms 23 of the holding elements 15. Further, the guide pieces 24 guide the connection cords 19a to 19c from near the support shafts 25 to the rear surface of the base 10. Accordingly, the rigidity of the connection cords 19a to 19c and tensile force or pushing force applied to the connection cords 19a to 19c are prevented from hindering pivoting of the holding elements 15.

(6) The terminals 18 of the contact fittings 12a to 12c are located above the bottom end of the contact fittings 12a to 12c. Thus, even when liquid (cleaning water or the like) enters the openings 29 of the base 10 and moves along the contact fittings 12a to 12c, the liquid does not remain at the terminals 18. This prevents corrosion at the soldered portion of the connection cords 19a to 19c and the terminals 18.

(7) The tabs 35 formed on the rear surface of the holding unit 2 hold the connection cords 19a to 19c. This holds the connection cords 19a to 19c in a loose state with the holding elements 15, the tabs 35, and further fasteners. Thus, damage is prevented to the connection cords 19a to 19c and the contact unit 11 that would result from unnecessary tightening of the connection cords 19a to 19c when assembling the contact unit 11, which includes the connection cords 19a to 19c, and the holding unit 2, which includes the contact unit 11.

It should be apparent to those skilled in the art that the present invention may be embodied in many other specific forms without departing from the spirit or scope of the invention. Particularly, it should be understood that the present invention may be embodied in the following forms.

The holder may be used as a cleaning device, charging device, or the like for various types of compact electric devices other than an electric shaver.

The material of the holding elements 15 is not limited to synthetic resin.

The present examples and embodiments are to be considered as illustrative and not restrictive, and the invention is not to be limited to the details given herein, but may be modified within the scope and equivalence of the appended claims.

1. A holder that holds a compact electric device, the holder comprising:
a contact fitting that resiliently contacts a contact arranged in a surface of the electric device;
a holding element coupled to the contact fitting and supported by the holder; and
an urging portion that urges the contact fitting from the holder toward the contact of the electric device.

2. The holder according to claim 1, wherein:
the contact fitting is formed from a metal plate; and
the holding element includes flanges sandwiching and holding the contact fitting.

3. The holder according to claim 2, wherein:
the contact fitting includes a cut edge; and
the flanges have a height set such that the flanges cover the cut edge of the contact fitting.

4. The holder according to claim 1, wherein:
the holding element includes a basal portion pivotally supported by the holder; and
the urging portion is arranged so that a pushing point of the urging portion is located between a pushing point of the contact relative to the contact fitting and a pivot point of the holding element.

5. The holder according to claim 1, wherein the holding element is pivotally supported by the holder and includes a guide piece that guides a connection cord, which is connected to the contact fitting, to near a pivot point of the holding element.

6. The holder according to claim 5, wherein:
the contact fitting includes a terminal connected to the connection cord; and
the terminal is located above a lower end of the contact fitting.

7. The holder according to claim 5, further comprising a cord holding portion that holds a middle part of the connection cord in an immovable manner.
